(19) United States
(12) Patent Application Publication
(10) Pub. No.: US 2009/0305008 A1
(43) Pub. Date: Dec. 10, 2009

(54) SURFACE COLOR PATTERNING WHILE DRAWING POLYMER ARTICLES

(76) Inventors: Kevin L. Nichols, Freeland, MI (US); James J. O'Brien, Midland, MI (US); Andrew T. Graham, Midland, MI (US); Gregory T. Stewart, Midland, MI (US); Claude Brown, JR., Saginaw, MI (US)

Correspondence Address: The Dow Chemical Company, Intellectual Property Section, P.O. Box 1967, Midland, MI, 48641-1967, US

(21) Appl. No.: 12/478,192

(22) Filed: Jun. 4, 2009

Related U.S. Application Data
(60) Provisional application No. 61/060,265, filed on Jun. 10, 2008.

(51) Int. Cl. B32B 5/14; B29C 47/04

(52) U.S. Cl. 428/195.1; 264/75

(57) ABSTRACT

Prepare an oriented polymer composition having a decorative appearance by a process including extruding an orientable polymer composition from an extruder, directing the orientable polymer composition through a calibrator and then drawing the orientable polymer composition, optionally through a drawing die, at a drawing temperature to form an oriented polymer composition wherein the process further includes disposing a colorant onto a surface of the oriented polymer composition prior to the calibrator, prior to the drawing die or both prior to a calibrator and prior to the drawing die in a pattern having a width of at least five millimeters and that preferably so that the colorant is at least partially located on a recessed portion of the resulting oriented polymer composition's surface and/or extends to a depth of at least one millimeter below the oriented polymer composition's surface.

### CROSS REFERENCE STATEMENT

This application claims the benefit of U.S. Provisional Application No. 61/060,265, filed Jun. 10, 2008.

### BACKGROUND OF THE INVENTION

1. Field of the Invention

The present invention relates to an oriented polymer composition and a process for producing oriented polymer compositions.

2. Description of Related Art

There is a desire to prepare polymer articles having color patterns that create decorative appearances such as natural wood grain in or on the polymer articles.

One way to achieve natural wood grain patterns with colorants is by processing a base resin and a color concentrate together in an extruder and then extruding the mixture (see, for example, U.S. Pat. Nos. 4,048,101; 4,280,950; 5,387,381; and PCT publication WO 97/04019). Such a process produces an extruded product having colorant dispersed throughout the resulting polymer composition. Having colorant dispersed throughout the polymer composition is desirable to provide depth to the colorant pattern so that the pattern survives scuffs and abrasion of the polymer composition's surface (see, for example, the discussion of disadvantages of prior art in U.S. Pat. No. 4,280,950 at column 1, lines 21-24). On the other hand, having colorant dispersed throughout the polymer composition is inefficient since much of the colorant is internal to the composition and serves no purpose. Furthermore, mixing colorant with a base polymer in an extruder affords little if any control defining colorant placement and patterns (see, for example, U.S. Pat. No. 5,387,381 at column 2, lines 7-12). Precise placement of colorant patterns is difficult, if even possible, in such a process. Therefore, there is opportunity to increase efficiency and control over the addition of colorant to polymer compositions to create decorative designs.

One type of article that would benefit from optimizing addition of colorant to create a decorative appearance, especially that of a natural wood grain pattern, is an oriented polymer composition (OPC). An OPC comprises polymers oriented primarily in a single direction. An OPC has a higher strength and flexural modulus than the same polymer composition before orientation. The higher strength and flexural modulus of OPCs make them ideal for structural applications such as siding, decking, fencing and flooring, which typically utilize wood.

Two publications report applying to the surface of an orientable polymer composition ink markings that remain after orientation to form an OPC. The markings are for determining the linear draw ratio of the drawing process (see, W. R. Newson and F. R. Maine, ORIENTED POLYPROPYLENE COMPOSITIONS MADE WITH MICA and W. R. Newson and F. R. Maine, ORIENTED POLYPROPYLENE COMPOSITES MADE WITH CALCIUM CARBONATES, both are handouts from 8^{th} International Conference on Woodfiber-Plastic Composites, Madison, Wis., May 23-25, 2005). These references describe measuring the extension of ink markings on the surface of a polymer composition to determine linear draw ratio after drawing the polymer composition. The linear draw ratio is the ratio of the length of the elongated marking after drawing to the length of the marking prior to drawing. As explained later with discoveries of the present invention, the marking is likely a straight line with negligible width and that extends the drawing direction of the OPC or determination of an accurate linear draw ratio would be difficult if possible. It is desirable to produce colorant patterns more exotic and visually interesting than elongated lines on an OPC, and to create the colorant patterns that have greater wear resistance than a mere marking on a surface of an OPC.

A process for producing an OPC having a decorative pattern, particularly a natural wood grain pattern, is desirable. Further desirable is such a process that efficiently uses colorant and allows precise control over the placement of colorant in a polymer composition. Yet more desirable is such a process that provides an OPC having a decorative pattern that benefits from greater wear-resistance than achievable by applying an ink marking to a surface of a polymer composition.

### BRIEF SUMMARY OF THE INVENTION

The present invention advances the art of oriented polymer compositions by providing a process for producing an OPC article having decorative colorant patterns that allows efficient use of colorant, control over the placement of colorant, benefits from inhomogeneous drawing of a polymer composition and/or that can provide an OPC having a decorative pattern having greater wear-resistance than achievable by applying an ink marking to a surface of a polymer composition.

In one regard, the present invention advances the art of oriented polymer compositions by providing a process for producing an oriented polymer composition (OPC) having greater control over decorative patterns than prior art processes. Unlike prior processes used to create decorative patterns on polymer compositions, particularly OPCs, the present process allows the ability to directly dispose colorant in specific locations on or in an orientable polymer to create specific colorant patterns in a final OPC.

In a second regard, the present invention surprisingly enables an artisan to preferentially locate colorant proximate to a surface of the OPC so wasteful blending of a colorant into a base resin is unnecessary.

In yet another regard, research leading to the present invention revealed a surprising result that drawing non-cylindrical polymer articles facilitates achieving non-homogeneous polymer movement during drawing and achieving decorative colorant patterns on an OPC, particularly patterns that resemble natural-wood. It became apparent that desirable distortions of colorant patterns can occur by inhomogeneous drawing of a polymer composition. For example, drawing an orientable polymer composition having a rectangular cross section with colorant extending in a straight line across the width of the orientable polymer composition has a tendency to cause the straight line to distort into a chevron-like pattern that simulates wood grain in a flat sawn (or nearly flat sawn) wooden board. Other distortions are also possible depending on the shape of the orientable polymer composition and conditions of drawing the orientable polymer composition.

FIGS. 1a and 1b illustrate this surprising result of inhomogeneous surface polymer displacement during drawing. FIG. 1a illustrates a major surface of a polymer composition that has a rectangular cross section prior to drawing the polymer composition. The major surface has ink lines extending across the major surface perpendicular to the drawing direction. The ink lines were drawn as straight lines extending across the orientable polymer composition prior to going through a calibrator. The lines became slightly distorted to a chevron-like shape even through the calibrator. FIG. 1b illustrates one of those same lines after drawing the polymer composition through a drawing die and reveals that the lines have been distorted to form a chevron-like pattern with the portion of line more proximate to the centroid of a cross section of the polymer composition (which coincides with being central to the width of the board) further along in the drawing direction than portions of the lines more remote from the centroid of the cross section (coinciding with being closer to the edges of the surface). Moreover, the line is spread apart more proximate to the center of the surface (most proximate to the centroid of the cross section) than portions of the line closer to the edges of the surface (less proximate to the centroid of the cross section). This inhomogeneous displacement of surface polymer is particularly useful in creating non-linear color patterns including exotic surface color patterns, especially wood grain patterns. Notably, flat sawn, or nearly flat sawn wooden boards tend to have grain patterns that are chevron shaped color patterns having a peak and tails wherein the color pattern is broader towards the peak than the tails (see, for example, FIG. 2 that illustrates the grain pattern in a board of ash wood). Polymer motion through the calibrator and drawing die is to the right in FIGS. 1a and 1b.

Discovery of this surprising result requires drawing a polymer composition that has a surface marking with sufficient breadth in a dimension perpendicular to the drawing direction (that is, sufficient width) to reveal inhomogeneity in polymer displacement. Research (see Example 2 below) reveals that such a width is generally at least five millimeters. As a result, it is unlikely the markings described in prior art to determine linear draw ratio have sufficient width to have revealed the inhomogeneity in polymer displacement and the references make no mention of such a surprising result (see, W. R. Newson and F. R. Maine, ORIENTED POLYPROPYLENE COMPOSITIONS MADE WITH MICA and W. R. Newson and F. R. Maine, ORIENTED POLYPROPYLENE COMPOSITES MADE WITH CALCIUM CARBONATES, both are handouts from 8^{th} International Conference on Woodfiber-Plastic Composites, Madison, Wis., May 23-25, 2005).

In still yet another regard, the process of the present invention advances the prior art by providing an OPC having colorant that is preferentially proximate to a surface of the OPC while still achieving scuff, scratch and wear resistance beyond that of a colorant merely disposed on a surface of the OPC. The process provides a method for embedding the colorant into the orientable polymer composition through a surface so that the colorant penetrates into the polymer composition below the polymer composition's surface and produces an OPC having a color pattern that tends to be more wear-resistant (for example, greater durability through repeated abrasion) than an OPC having a color pattern only on its surface.

In a first aspect, the present invention is a process for preparing an oriented polymer composition comprising the steps of: (a) providing a calibrator, a colorant, and an orientable polymer composition that has a surface, softening temperature and a width (b) extruding the orientable polymer composition at a temperature above the orientable polymer composition's softening temperature; (c) directing the orientable polymer composition through a calibrator; (d) conditioning the orientable polymer composition to a drawing temperature at which the polymer composition is in a solid state; and (e) initiating drawing of the orientable polymer composition while the orientable composition is in a solid state and drawing the orientable polymer composition into an oriented polymer composition; wherein step (d) occurs during or after step (c) but occurs prior to step (e) and further comprising a step of adding a colorant to one or more than one surface of the orientable polymer composition in one or both of the following places in the process: (i) after exiting the extruder and before exiting the calibrator; and (ii) after exiting the calibrator and before completion of the drawing step; and wherein the colorant is part of a colorant pattern that has a width of at least five millimeters.

Desirable embodiments of the first aspect include any one or any physically possible combination of more than one of the following further characteristics: addition of colorant during (i) occurs prior to the calibrator; drawing in step (e) includes drawing the orientable polymer composition through a drawing die wherein the orientable polymer composition is in a solid state as it enters the drawing die and addition of colorant during (ii) occurs prior to a drawing die; the step of adding colorant to a surface includes directly impressing colorant into the surface so that the colorant resides in a recessed portion of the orientable polymer composition's surface; at least a portion of the colorant becomes embedded into the orientable polymer composition so as to extend to a depth below the surface of the orientable polymer composition to which it was added of at least one millimeter in the resulting oriented polymer composition; the colorant resides exclusively within five millimeters of a surface of the oriented polymer composition; the orientable polymer composition and oriented polymer composition are non-cylindrical; step (c) continuously follows step (b) and steps (d) and (e) continuously follow step (c); step (c) continuously follows step (b) and colorant is added to at least one surface of the orientable polymer composition between steps (b) and (c); the colorant resides at least partially above the surface of the orientable polymer composition before the orientable polymer composition goes through the calibrator; the colorant comprises a pigment in a carrier wherein the carrier is selected from a group consisting of a thermoplastic polymer matrix, organic liquids, organic solvents, aqueous liquids and aqueous solvents; the colorant comprises a pigment in a thermoplastic polymer matrix; the colorant is adhesively compatible with the orientable polymer composition; drawing in step (e) occurs at such a rate that necking of the orientable polymer composition is complete while the orientable polymer composition has cross sectional dimensions that all exceed two millimeters; and addition of the colorant comprises applying colorant in a non-linear pattern.

In a second aspect, the present invention is an article of manufacture that is an orientable polymer composition that has been oriented into an oriented polymer composition, the oriented polymer composition comprising an orientable polymer composition and a colorant; wherein the oriented polymer composition has at least one surface and a core, and a dimension of primary orientation and wherein the colorant is part of a colorant pattern having a width of at least five millimeters.

Desirable embodiments of the second aspect include any one or any physically possible combination of more than one of the following further characteristics: at least a portion of the colorant resides in a recessed portion of the orientable polymer composition's surface; at least a portion of the colorant extends to a depth of at least one millimeter below a surface of the oriented polymer composition and is preferentially located proximate to the surface of the oriented polymer composition as opposed to the core of the oriented polymer composition; colorant is exclusively located within five millimeters of at least one surface of the oriented polymer composition; the colorant is adhesively compatible with the orientable polymer composition; the oriented polymer composition is non-cylindrical; and the colorant forms a non-linear pattern.

The process of the present invention is useful for manufacturing the OPC of the present invention. The OPC of the present invention is useful for structural applications such as decking materials (for example, deck boards, railings, and decorative trim), siding materials, fencing and flooring.

### BRIEF DESCRIPTION OF THE DRAWINGS

FIGS. 1a and 1b illustrate what were straight lines drawn perpendicular to the flow or drawing direction on an orientable polymer composition prior to entering a calibrator and reveals inhomogeneous distortion of the lines after passing through a calibrator and drawing die. FIG. 1a illustrates distortion of the lines after exiting the calibrator. FIG. 1b illustrates distortion of the lines after further undergoing drawing. Drawing direction is to the right.

FIG. 2 illustrates wood grain of a board of Ash wood.

FIG. 3 illustrates a schematic layout of an embodiment of a continuous process of the present invention.

FIG. 4 illustrates elongation of straight lines extending in the drawing direction drawn on an orientable polymer composition after a calibrator and prior to drawing. Drawing direction is to the left.

### DETAILED DESCRIPTION OF THE INVENTION

“ASTM” refers to American Society for Testing and Materials. The ASTM test methods described herein refer to the test method of the year designated by the hyphenated suffix or, in an absence of a hyphenate suffix, the most recent test method as of the priority date of the present specification.

“Solid state” refers to a polymer (or polymer composition) that is below the softening temperature of the polymer (or polymer composition). Hence, “solid state drawing” refers to drawing a polymer or polymer composition that is at a temperature below the softening temperature of the polymer (or polymer composition).

“Polymer composition” comprises at least one polymer component and can contain non-polymeric components. A polymer composition has at least one surface, a core, and a softening temperature.

“Cylindrical” refers to an article having a circular cross section.

“Non-cylindrical” refers to an article or composition that has a non-circular cross section. Desirably, an oriented polymer composition that is non-cylindrical within the scope of the present invention has a maximum cross sectional aspect ratio that is two or more, preferably three or more and can be five or more, ten or more, even twenty or more. Typically, an oriented polymer composition within the scope of the present invention has a maximum cross sectional aspect ratio that is 100 or less, preferably 50 or less, more preferably 25 or less and can be twenty or less, even ten or less.

“Cross sections” of an oriented polymer composition are perpendicular to the drawing axis of the oriented polymer composition unless the reference to the cross section indicates otherwise. A cross section has a centroid and a perimeter that defines a shape for the cross section.

“Drawing axis” is a straight line through an oriented polymer composition that is parallel to the direction of primary alignment of the polymers in the oriented polymer composition. When an orientable polymer composition is drawn in only one direction the drawing axis extends in the direction that the center of mass (centroid) of the polymer composition is moving as the polymer composition is drawn in a solid state drawing process.

A “cross sectional dimension” is the length of a straight line connecting two points on a cross section's perimeter and extending through the centroid of the cross section. For example, a cross sectional dimension of a rectilinear four-sided polymer composition could be the height or width of the polymer composition.

“Surface” of a polymer composition refers to that portion of the polymer composition that interfaces with the environment surrounding the polymer composition. Generally, a polymer composition is considered to have more than one surface, with each surface distinguished from another surface by an edge. A sphere, for example, has a single surface and is free of edges. A rectangular box, on the other hand, has six surfaces and 12 edges.

“Major surface” refers to a surface having a planar surface area equal to or greater than that of any other surface of an article.

“Planar surface area” is the surface area as projected onto a plane and serves to take into account the surface area without accounting for peaks, valleys or cavities in the surface.

“Core” of a polymer composition is a three dimensional centroid for the polymer composition. When viewing a cross section of a polymer composition the surface defines the perimeter of the cross section while the core is the centroid of the cross section.

“Softening temperature” (Ts) for a polymer or polymer composition having as polymer components only one or more than one semi-crystalline polymer is the melting temperature for the polymer composition.

“Melting temperature” (Tm) for a semi-crystalline polymer is the temperature half-way through a crystalline-to-melt phase change as determined by differential scanning calorimetry (DSC) upon heating a crystallized polymer at a specific heating rate. Determine Tm for a semi-crystalline polymer according to the DSC procedure in ASTM method E794-06. Determine Tm for a combination of polymers and for a filled polymer composition also by DSC under the same test conditions in ASTM method E794-06. If the combination of polymers or filled polymer composition only contains miscible polymers and only one crystalline-to-melt phase change is evident in its DSC curve, then Tm for the polymer combination or filled polymer composition is the temperature half-way through the phase change. If multiple crystalline-to-melt phase changes are evident in a DSC curve due to the presence of immiscible polymers, then Tm for the polymer combination or filled polymer composition is the Tm of the continuous phase polymer. If more than one polymer is continuous and they are not miscible, then the Tm for the polymer combination or filled polymer composition is the lowest Tm of the continuous phase polymers.

“Softening temperature” (Ts) for a polymer or polymer composition having as polymer components only one or more than one amorphous polymer is the glass transition temperature for the polymer composition.

“Glass transition temperature” (Tg) for a polymer or polymer composition is as determined by DSC according to the procedure in ASTM method E1356-03. Determine Tg for a combination of polymer and for a filled polymer composition also by DSC under the same test conditions in ASTM method E1356-03. If the combination of polymer or filled polymer composition only contains miscible polymers and only one glass transition phase change is evident in the DSC curve, then Tg of the polymer combination or filled polymer composition is the temperature half-way through the phase change. If multiple glass transition phase changes are evident in a DSC curve due to the presence of immiscible amorphous polymers, then Tg for the polymer combination or filled polymer composition is the Tg of the continuous phase polymer. If more than one amorphous polymer is continuous and they are not miscible, then the Tg for the polymer composition or filled polymer composition is the lowest Tg of the continuous phase polymers.

If the polymer composition contains a combination of semi-crystalline and amorphous polymers, the softening temperature of the polymer composition is the softening temperature of the continuous phase polymer or polymer composition. If the semi-crystalline and amorphous polymer phases are co-continuous, then the softening temperature of the combination is the lower softening temperature of the two phases.

“Drawing temperature” is a temperature within a drawing temperature range at which a polymer is conditioned prior to drawing and is the temperature at which the polymer exists upon the initiation of drawing.

An artisan understands that a polymer composition typically has a variation in temperature through its cross section (that is, along a cross sectional dimension of the composition) during processing. Therefore, reference to temperature of a polymer composition refers to an average of the highest and lowest temperatures along a cross sectional dimension of the polymer composition. The temperature at two different points along the polymer cross sectional dimension desirably differs by 10 percent (%) or less, preferably five % or less, more preferably one % or less, most preferably by 0% from the average temperature of the highest and lowest temperature along the cross sectional dimension. Measure the temperature in degrees Celsius (° C.) along a cross sectional dimension by inserting thermocouples to different points along the cross sectional dimension.

### Drawing Process and Oriented Polymer Composition

One aspect of the present invention is a process for preparing an oriented polymer composition (OPC) from an orientable polymer composition and in another aspect the present invention is an OPC. The OPC and the orientable polymer composition each comprises a continuous phase of orientable polymer. Typically, 75 weight-percent (wt %) or more, even 90 wt % or more or 95 wt % or more of the polymers in an OPC and orientable polymer composition are orientable polymers. The orientable polymers of an OPC are preferentially aligned along a single axis, which give rise to the term “oriented”. The oriented nature of the polymers in an OPC provides desirable characteristics to an OPC over a non-oriented polymer composition including increased flexural modulus and strength.

An orientable polymer is a polymer that can undergo induced molecular orientation by solid state deformation (for example, solid state drawing). An orientable polymer can be amorphous or semi-crystalline (semi-crystalline polymers have a melt temperature (Tm) and include those polymers known as “crystalline”). Desirable orientable polymers include semi-crystalline polymers, even more desirable are linear polymers (polymers in which chain branching occurs in less than 1 of 1,000 polymer units). Semi-crystalline polymers are particularly desirable because they result in greater increase in strength and modulus than amorphous polymer compositions. Semi-crystalline polymer compositions can result in 4-10 times greater increase in strength and flexural modulus upon orientation over amorphous polymer compositions.

Suitable orientable polymers include polymers and copolymers of polystyrene, polypropylene, polyethylene (including high density polyethylene), polymethylpentane, polytetrafluoroethylene, polyamides, polyesters such as polyethylene terephthalate and polybutylene terephthalate, polycarbonates, polyethylene oxide, polyoxymethylene and blends thereof. Particularly desirably orientable polymers include polyethylene, polypropylene, and polyesters. More particularly desirable orientable polymers include linear polyethylene having a weight-average molecular weight from 50,000 to 3,000,000; especially from 100,000 to 1,500,000, even from 750,000 to 1,500,000. Polyvinylidene fluoride polymers having a weight-average molecular weight of from 200,000 to 800,000, preferably 250,000 to 400,000 are also suitable. Another desirable polymer is high density polyethylene having a density in a range of 0.941 to 0.959 grams per cubic centimeters and a weight-average molecular weight of 110,000 grams per mole or higher, preferably 156,000 grams per mole or higher, yet more preferably 190,000 grams per mole or higher. Such a high density polyethylene is particularly conducive to high drawing speeds without breaking.

Polypropylene (PP)-based polymers are especially desirable for use in the present invention. PP-based polymers generally have a lower density than other orientable polymers. Therefore, PP-based polymers facilitate lighter articles than other orientable polymers. Additionally, PP-based polymers offer greater thermal stability than other orientable olefin polymers. Therefore, PP-based polymers may also form oriented articles having higher thermal stability than oriented articles of other polymers.

Suitable PP-based polymers include Zeigler Natta, metallocene and post-metallocene polypropylenes. Suitable PP-based polymers include PP homopolymer; PP random copolymer (with ethylene or other alpha-olefin present from 0.1 to 15 percent by weight of monomers); PP impact copolymers with either PP homopolymer or PP random copolymer matrix of 50-97 percent by weight (wt %) based on impact copolymer weight and with ethylene propylene copolymer rubber present at 3-50 wt % based on impact copolymer weight prepared in-reactor or an impact modifier or random copolymer rubber prepared by copolymerization of two or more alpha olefins prepared in-reactor; PP impact copolymer with either a PP homopolymer or PP random copolymer matrix for 50-97 wt % of the impact copolymer weight and with ethylene-propylene copolymer rubber present at 3-50 wt % of the impact copolymer weight added via compounding, or other rubber (impact modifier) prepared by copolymerization of two or more alpha olefins(such as ethylene-octene)by Zeigler-Natta, metallocene, or single-site catalysis, added via compounding such as but not limited to a twin screw extrusion process.

The PP-based polymer can be ultra-violet (UV) stabilized, and desirably can also be impact modified. Particularly desirable PP-based polymers are stabilized with organic stabilizers. The PP-based polymer can be free of titanium dioxide pigment to achieve UV stabilization thereby allowing use of less pigment to achieve any of a full spectrum of colors. A combination of low molecular weight and high molecular weight hindered amine-type light stabilizers (HALS) are desirable additives to impart UV stabilization to PP-based polymers. Suitable examples of commercially available stabilizers include IRGASTAB™ FS 811, IRGASTAB™ FS 812 (IRGASTAB is a trademark of Ciba Specialty Chemicals Corporation). A particularly desirable stabilizer system contains a combination of IRGASTAB™ FS 301, TINUVIN™ 123 and CHIMASSORB™ 119. (TINUVIN and CHIMASSORB are trademarks of Ciba Specialty chemicals Corporation).

The orientable polymer composition, as well as OPC of the present invention, may contain fillers including organic, inorganic or a combination of organic and inorganic fillers. It is desirable for inorganic fillers to account for 50 volume percent (vol %) or more, preferably 75 vol % or more, and most preferably 100 vol % of the total volume of filler. Inorganic fillers are more desirable than organic fillers for numerous reasons including that inorganic fillers tend to be more thermally stable and resistant to decay and discoloration. The fillers, if present, exist dispersed within, preferably throughout the entire orientable polymer composition and OPC.

Suitable organic fillers include cellulosic materials such as wood flour, wood pulp, flax, rice hulls or any natural fiber. Rubber particles are also suitable organic filler. Suitable inorganic filler include mica, talc (including any or a combination of materials and grades commonly known and available as “talc”), chalk, titanium dioxide, clay, alumina, silica, glass beads, calcium carbonate, magnesium sulfate, barium sulfate, calcium oxysulfate, tin oxide, metal powder, glass powder, pigments, minerals, glass, ceramic, polymeric or carbon reinforcing agents, glass fibers, carbon fibers, wollastonite, graphite, magnesium carbonate, alumina, metal fibers, kaolin, silicon carbide, and glass flake.

Fillers can serve many purposes including serving to enhance flame retardancy, induce cavitation during the drawing process, and provide partial reinforcement of an article. Inorganic fillers are more desirable than organic fillers in the present invention because organic fillers can undergo charring, and associated discoloration, upon heating a surface of the cavitated OPC to form a de-oriented longitudinal surface layer. Organic fillers also tend to fade over time with exposure to ultraviolet radiation.

The orientable polymer composition, and hence, the resulting OPC, can further contain additives that enhance flame retardancy, foaming agents, or any other additives common to plastic processing.

The orientable polymer composition has a softening temperature. In an embodiment of the present invention, extrude an orientable polymer composition at a temperature above the orientable polymer composition's softening temperature. Direct the orientable polymer composition through a calibrator. Ideally, the calibrator smoothes the surface or surfaces of the orientable polymer composition. In a desirable embodiment, cool the surface of the orientable polymer composition within the calibrator to a temperature below the orientable polymer composition's softening temperature in order to stabilize the shape of the orientable polymer composition sufficiently to enable the orientable polymer composition to retain its shape without deformation as it travels from the calibrator. Typically, the calibrator cools the orientable polymer composition sufficiently to create a skin around the orientable polymer composition (“around” meaning sufficient to exist around a cross sectional circumference) that is at a temperature equal to or below Ts. The skin desirably extends from the orientable polymer composition's surface to a depth of 0.5 millimeters (mm) or more, preferably one mm or more to create a cooled skin around the orientable polymer composition (around a cross sectional circumference). The necessary depth of cooling depends on the total dimensions of the orientable polymer composition, with orientable polymer compositions having larger cross sections requiring a thicker cooled skin. Sufficient cooling is achieved if the polymer composition remains of constant shape upon exiting the calibrator and prior to any further manipulation, such as drawing.

A calibrator has a calibrator channel that extends through the calibrator from one end through an opposing end. The calibrator channel comprises a land-type section that defines and holds the shape of the orientable polymer composition, preferably as the orientable polymer composition cools. The calibrator channel typically comprises a flared entrance opening into which the orientable polymer composition enters the calibrator prior to the land-type section. The land-type section is essentially uniform in cross sectional area and shape and is desirably long enough to house the orientable polymer composition as it cools.

It is desirable for the calibrator to continuously follow an extruder so that an orientable polymer composition may continuously proceed from the extruder through the calibrator. The calibrator may be attached to the extruder or be remote from the extruder. Desirably, the position of the calibrator relative to the extruder allows for addition of colorant to a polymer composition between the extruder and calibrator. Therefore, if the calibrator is attached to the extruder there is desirably an opening to allow disposition of colorant onto one or more surface of an orientable polymer composition between the extruder and calibrator, within the end of the extruder or within the entrance to the calibrator. Preferably, the calibrator is distinct from the extruder, meaning there is a space between the extruder and calibrator that extends all the way around the circumference of an orientable polymer composition traveling between the extruder and calibrator. Such an orientation provides access, preferably unhindered access to any portion of the orientable polymer composition's surface for addition of colorant.

After the orientable polymer composition exits the calibrator, orient the orientable polymer composition to form an OPC by solid state drawing the orientable polymer composition at a drawing temperature. Draw the orientable polymer composition by applying tensile force to the orientable polymer composition that is of sufficient force to cause the orientable polymer composition to narrow in cross sectional area but not so high in force as to cause the orientable polymer to break (that is, to exceed the tensile strength of the orientable polymer composition). The direction of tensile force defines the drawing axis and drawing direction of the orientable polymer composition.

Drawing may occur continuously after the calibrator, meaning an orientable polymer composition may proceed as a continuous material from the calibrator through the drawing process. Alternatively, drawing may occur discontinuously from the rest of the process, meaning the orientable polymer may be drawn remote in time and/or location from when it was extruded and calibrated. For example, drawing of an orientable polymer composition can occur minutes, hours, days, weeks, months even years after exiting a calibrator. When drawing is discontinuous with calibrating, billets of orientable polymer composition are generally cut to a desired length after the calibrator and stored until drawn. Desirably, drawing occurs continually after the calibrator to maximize process efficiency.

Drawing may occur as a solid state free-drawing process, solid state die-drawing process, roller-drawing process (drawing through moving rollers) or any combination of these processes. Drawing processes utilize a tensile force to pull a polymer composition. Solid state free-drawing occurs by applying to a solid state orientable polymer composition a tensile force that is sufficient to cause the orientable polymer composition to elongate and orient in a drawing direction free of physical constraints directing how the cross section necks during elongation. Solid state die-drawing occurs by applying a tensile force to pull a solid state orientable polymer composition through a converging die that directs necking of the orientable polymer composition as the orientable polymer composition elongates and orients. An orientable polymer composition in a solid state die-drawing process can undergo free-drawing after exiting a solid state drawing die and thereby experience a combination of die-drawing and free-drawing. An orientable polymer composition may also neck away from a drawing die while still within the drawing die, thereby experiencing free-drawing while still within the drawing die. It is most desirable to use a solid state drawing die in order to control the final cross sectional shape of the resulting OPC. Even if some free-drawing occurs after the solid state drawing die, the die generally will direct the free drawing and offer better control over final OPC dimensions than a free-draw process that does not use a solid state drawing die.

Suitable solid state drawing dies for use in the process of the present invention include any converging die. Desirably, the drawing die is a substantially proportional die as described in published U.S. patent application 2008-0111277 (incorporated herein by reference in its entirety). A substantially proportional die has a shaping channel extending entirely through it—that is, through and from one end of the die to and through an opposing end of the die. Orientable polymer composition travels through the shaping channel. Each cross section of the shaping channel is proportional to any other cross section of the shaping channel. Herein, “proportional” allows for some tolerance in interpretation from being perfectly proportional to any measurable extent. Instead, two cross sections are still “proportional” within the scope of the term herein if the cross sections have deviations of 5% or less, preferably 3% or less, more preferably 1% or less from proportional. Determine percent deviation from proportional by dividing the ratio of two cross sectional dimensions for a smaller cross section by a ratio of the same cross sectional dimensions for another larger cross section, subtracting that value from one and multiplying by 100%.

It is desirable to draw the orientable polymer composition at a drawing temperature (Td) in a drawing temperature range of 0-50° C. below the orientable polymer composition's Ts. Preferably, Td for an orientable polymer composition is 40° C. or less, more preferably 25° C. or less, still more preferably 15° C. or less below the orientable polymer composition's Ts and can be one ° C. or more, even five ° C. or more below the orientable polymer composition's Ts. When using a solid state drawing die it is desirable to maintain the die at a temperature at or below Ts of the orientable polymer composition being drawn. It is also desirable to maintain the orientable polymer composition at a drawing temperature while drawing the orientable polymer composition, particularly while the orientable polymer composition is in a solid state drawing die. An orientable polymer composition is “drawing” while it is contracting in cross sectional area (“necking”) under a tensile drawing force.

Draw the orientable polymer composition at a drawing rate. Drawing rate is a measure of linear distance the orientable polymer composition travels over time. Generally, the more an orientable polymer composition necks, cavitates or converges during a drawing process, the faster the drawing rate becomes. It is general practice to define as the drawing rate for an entire drawing process the fastest linear rate the orientable polymer composition experiences during the entire drawing process, which is typically the rate at which the final OPC is manufactured. This is the convention used herein unless otherwise stated.

One of ordinary skill in the art understands that an orientable polymer composition may experience multiple local or intermediary drawing rates during an entire drawing process. For example, an orientable polymer composition may have one drawing rate after a drawing die and yet increase drawing rate by free-drawing after the drawing die. Similarly, an orientable polymer composition increases drawing rate as it experiences free-drawing or die-drawing. These processes can be construed as having variable drawing rates. Moreover, drawing can occur in multiple steps; thereby, experiencing multiple intermediary drawing rates. For example, using two different drawing dies in sequence will produce at least two different intermediary drawing rates, with the drawing rate after the second drawing die being faster than the drawing rate after the first die. All conceivable combinations and variations of drawing are within the scope of the present invention. One of ordinary skill in the art recognizes that an overall drawing process may include multiple intermediate drawing steps, each of which may have an intermediary drawing rate that corresponds to the fastest linear rate the orientable polymer composition travels during that intermediary drawing step. Intermediary drawing rates are equal to or less than the drawing rate for the entire process.

One desirable embodiment of the present invention is a solid state die-drawing process that uses a drawing rate of 0.25 meter per minute (m/min) or faster, preferably 0.5 m/min or faster, still more preferably two m/min or faster drawing rate. Optimally, the drawing rate is 1.2 m/min or faster, preferably 2.4 m/min or faster and still more preferably 3.7 m/min or faster in order to maximize the ability to visually appreciate colorant pattern distortion due to inhomogeneous surface polymer displacement. An upper limit for drawing rate is limited only by the force necessary to achieve that drawing rate. The drawing force should not exceed the tensile strength at the drawing temperature of the orientable polymer composition being drawn otherwise the orientable polymer composition will fracture. Typically, the drawing rate is 30 m/min or slower.

The orientable polymer composition can undergo cavitation during the drawing process and thereby decrease in density. Cavitation is a process by which void volume forms proximate to filler particles or crystallites in an orientable polymer composition during a drawing process as polymer is drawn away from the filler particle or crystallite. Cavitation is a means of introducing void volume into an orientable polymer composition (and, hence, OPC) without having to use a blowing agent. The extent of cavitation that occurs during drawing is dependent upon drawing rate as well as filler and crystallite concentration. Increasing any of drawing rate, filler concentration or crystallite concentration or decreasing drawing temperature generally increases the extent of cavitation. A desirable embodiment of the process of the present invention induces cavitation during the drawing step to produce an OPC of the present invention that has cavitation void volume (that is, a cavitated OPC).

In one respect, the process of the present invention differs from other drawing processes by including addition of a colorant to one or more than one surface of the orientable polymer composition between the steps of: (a) extruding the orientable polymer composition and (b) directing the orientable polymer composition out from a calibrator; or between steps (b) and (c) completing solid state drawing of the orientable polymer composition; or both between steps (a) and (b) as well as (b) and (c). In a desirable embodiment, colorant is added between steps (a) and (b) and can be added exclusively between steps (a) and (b). While colorant can be added to a polymer composition while the polymer composition is in a calibrator, preferably colorant is added to the polymer composition prior to entering the calibrator when adding colorant between steps (a) and (b). That way, the calibrator can serve to impress or embed the colorant at least partially into the orientable polymer composition. Similarly, colorant can be added to a polymer composition while the polymer composition is in a drawing die between steps (b) (c) in a process using a solid state drawing die; however, colorant is preferably added to the polymer composition before the polymer composition enters a drawing die when colorant is added between steps (b) and (c).

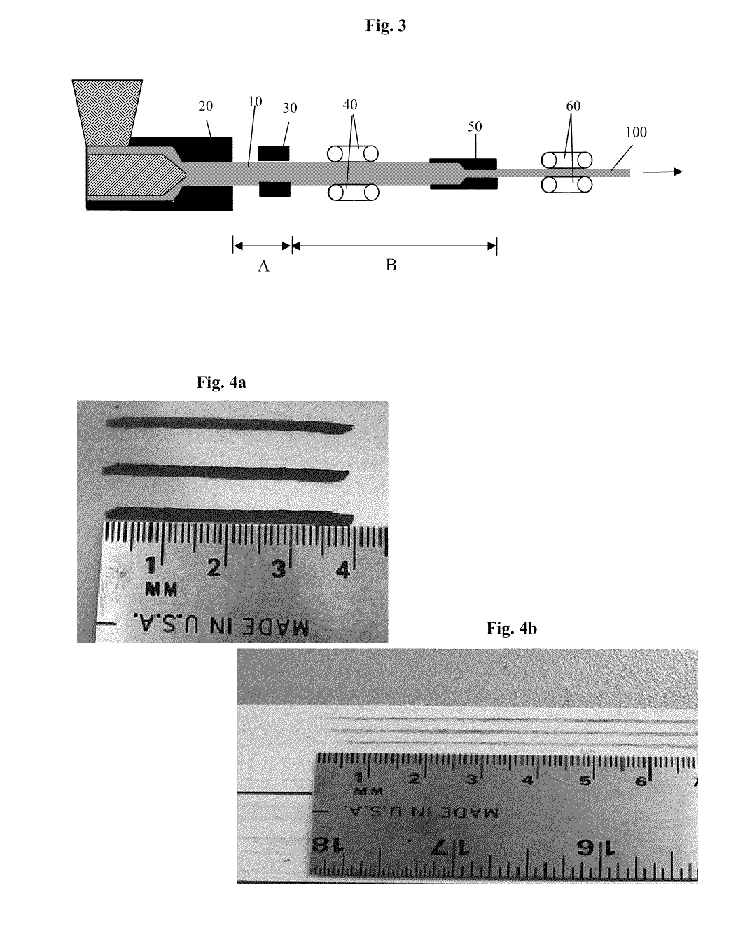

FIG. 3 provides an illustration of an embodiment of a continuous process within the scope of the present invention that is useful for understanding where colorant addition can occur. FIG. 3 illustrates orientable polymer composition 10 that exits extruder 20 and that travels through calibrator 30 with the assistance of haul off device 40. After traveling through haul off device 40, haul off device 60 applies sufficient tensile force on orientable polymer composition 10 to draw orientable polymer composition 10 through drawing die 50 thereby drawing orientable polymer composition 10 into OPC 100. Addition of colorant to orientable polymer composition 10 can occur between steps (a) and (b), which corresponds to addition in any part or over the entire length of section A in FIG. 3. Alternatively, or additionally, addition of colorant to orientable polymer composition 10 can occur between steps (b) and (c), which corresponds to addition in any portion or over the entire length of section B in FIG. 3.

Adding colorant between steps (a) and (b) and, or in an alternative, between steps (b) and (c) in the process offers tremendous advantages over other colorant addition methods, such as blending colorant into the orientable polymer composition in an extruder. One such advantage is the ability to specifically control the positioning of colorant in the orientable polymer composition. An artisan may dispose colorant into specific patterns on one or more than one surface of an orientable polymer composition in the present process. Such an advantage allows precise control over colorant patterns and pattern size in or on a final OPC that is not achievable when colorant is blended into an orientable polymer composition in an extruder. Another advantage the present process offers over other processes is that colorant is specifically disposed proximate to one or more surface of an orientable polymer composition and remains proximate to the one or more surface as opposed to the core of the orientable polymer composition. That is, the colorant is preferentially disposed proximate to one or more surface of an orientable polymer composition and remains preferentially located proximate to one or more surface of the orientable polymer composition when the orientable polymer composition becomes and OPC. That means that in a cross section of the OPC, colorant concentration will be more proximate to a surface as opposed to the core of the OPC. As a result, colorant is not wasted by residing proximate to the core of an OPC where it is not visible. Yet another advantage of the present invention is that one color pattern may be superimposed on another color pattern. For example, applying one color pattern, or combination of color patterns, between steps (a) and (b) and a second color pattern, or combination of color patterns, between steps (b) and (c) results in superimposing the second color pattern(s) over the first color pattern(s). The second color pattern(s) can be the same color or different color and the same or different pattern(s) than the first color pattern(s). As a result, more complex and precise color patterns, particularly non-linear color patterns, are possible in OPCs prepared with the present process than prepared with previous processes.

It is desirable in the present process to apply a colorant between steps (a) and (b), particularly before entering a calibrator, whether or not colorant is applied between steps (b) and (c). The surface of an orientable polymer composition is still at a temperature above its softening temperature before a calibrator and generally for at least a period of time while it is within the calibrator, which allows colorant to be readily impressed into the orientable polymer composition. Impressing colorant into a surface of the orientable polymer composition causes the colorant to reside at least partially below the surface of the orientable polymer composition, which typically adds depth to the color and wearability (for example, scuff resistance) to the color pattern in an OPC resulting from the orientable polymer composition. Between steps (b) and (c) the orientable polymer composition is generally in a solid state and impressing colorant in the orientable polymer composition is more difficult. Impressing colorant into an orientable polymer composition between steps (b) and (c) is possible though by, for example, using a heated embosser to impress colorant into polymer composition locally melted by the embosser design.

Colorant disposed on a surface of an orientable polymer composition prior to a calibrator can become impressed into the orientable polymer composition by the calibrator. Alternatively, the process may optionally include pressure applying means other than the calibrator that serves to impress colorant into an orientable polymer composition. The pressure applying means can impress colorant as colorant is disposed onto an orientable polymer composition or after a colorant disposing colorant onto an orientable polymer composition. For example, applying colorant to an orientable polymer composition using an embossing-type applicator can concurrently impress colorant into an orientable polymer composition while applying colorant to the orientable polymer composition. As another example, rollers may serve as pressure applying means that imbeds colorant already disposed onto a surface of an orientable polymer composition by rolling over the colorant along the orientable polymer composition surface. The optional pressure applying means are in addition to the calibrator and any drawing die, both of which can also serve to impress colorant into an orientable polymer composition during the process of the present invention. Desirably, dispose colorant and use a pressure applying means to imbed the colorant into the orientable polymer composition between the extruder and calibrator when the orientable polymer composition is softest. Examples of suitable pressure applying means include rollers, embossers, platens, belts, stamps and doctor blades.

In one embodiment of the present invention, a haul-off device can concurrently serve as a colorant applicator. For example, a haul-off device can be a caterpillar-type puller that applies an ink pattern as it contacts an orientable polymer composition in the present process. The haul-off device can even serve as an embossing roller with a heated embossing pattern that impresses into an orientable polymer composition as it draws the orientable polymer composition through the present process. The heated embossing pattern can include colorant that becomes embedded into the orientable polymer composition as the embossing pattern impresses into the polymer composition while the haul-off device simultaneously embosses and draws the orientable polymer composition. The haul-off device can apply colorant before or after the calibrator and can apply colorant to a surface of the orientable polymer composition, simultaneously emboss a surface of the orientable polymer composition and apply colorant to the resulting recessed surface, serve as a pressure applying means to embed previously added colorant into the orientable polymer composition or simultaneously apply and embed colorant into the orientable polymer composition (for example, by impressing colorant into the polymer composition and, optionally, compressing orientable polymer composition over the colorant).

Herein, “colorant” refers to any material or composition that imparts color. Suitable colorants include any one or combination of more than one of the following: dyes, fluorescents, interference colours, laser marking additives, liquid colours, luminescents, marble effect additives, metallic effect additives, non-cadmium additives, pastes, pearlescent additives, phosphorescent additives, photochromic additives, inorganic pigments, organic pigments, powder materials, sparkle effect materials, speckle and fleck materials, stone effect materials, thermochromic additives, wood effect materials, any one or any combination of more than one of these materials, and any one or any combination of more than one of these materials compounded into a polymer matrix (preferably a thermoplastic polymer, more preferably a semi-crystalline polymer, having a softening temperature 10-50° C. below the softening temperature of the orientable polymer composition). For example, a colorant in a high density polyethylene matrix is suitable for use with a polypropylene orientable polymer composition. Specific examples of suitable colorants include carbon black, iron oxides, titanium dioxide, aluminum hydroxide, barium sulfate and any combination of these materials compounded into a thermoplastic polymer such as high density polyethylene. Colorants can be entirely non-polymeric, inorganic, even both non-polymeric and inorganic.

“Colorant” includes neat pigments and pigments formulated in a carrier. Colorants can be in any form including liquid, powders, granules, pellets, as concentrates in a polymer matrix, even as polymeric materials that are in a form of shaped articles (for example, molded into specific three-dimensional shapes). Suitable carriers for pigments formulated in a carrier include polymer matrices, organic liquids and solvents and aqueous liquids and solvents. When colorant comprises a pigment in a polymeric matrix, the polymer matrix is desirably a thermoplastic polymer matrix that has a softening temperature lower than the orientable polymer composition and more preferably lower than the drawing temperature so that the colorant will elongate during the drawing step.

It is desirable to select a colorant that is adhesively compatible with an orientable polymer composition when using the colorant in a process with the orientable polymer composition. A colorant is “adhesively compatible” with an orientable polymer composition if at least a portion of the colorant becomes chemically, mechanically, ionically or even electromagnetically bound to the orientable polymer composition upon application of the colorant to the orientable polymer composition and drawing the polymer composition into an OPC. Applying a colorant to an orientable polymer composition that is adhesively compatible with the orientable polymer composition produces a pattern that has a greater durability (for example, greater scuff, weather and wear resistance) than a colorant that is not adhesively compatible with the orientable polymer composition. Notably, a colorant that is minimally or non-adhesively compatible with an orientable polymer composition when applied to a surface of the orientable polymer composition may become adhesively compatible by imprinting the colorant into the surface of the orientable polymer composition by, for example, enhancing mechanical bonding between the colorant and orientable polymer composition.

Determine whether a colorant is adhesively compatible with an orientable polymer composition using a cross hatch adhesion test method similar to that described in ASTM D3359. The test method is for testing adhesion of a coating to a substrate. The test method is equally useful to evaluate adhesion of a colorant to an orientable polymer composition. Apply the test method to an OPC of the present invention (that is, an OPC made according to the process of the present invention) to evaluate adhesion of the colorant by applying the procedure of the test method to a surface of the OPC containing colorant. A colorant is “adhesively compatible” with an orientable polymer composition if under such a test method if less than 25%, preferably 10% or less, more preferably 5% or less, still more preferably 1% or less of the pigment visible on a surface of the OPC being tested is removed during the cross hatch adhesion test.

Add one or more than one colorant to one or more than one surface of an orientable polymer composition by any conceivable means including spraying, dropping, rolling, printing (for example, ink jet printing, offset printing and stamping), imprinting, embossing or impressing (by, for example, pressing or stamping), brushing, sprinkling, blowing, transfer film deposition, etching, and stenciling.

In one desirable embodiment, sprinkle powdered pigment on an orientable polymer composition after the orientable polymer composition exits an extruder and before the orientable polymer composition enters a calibrator. The powdered pigment becomes embedded into the surface of the orientable polymer composition within the calibrator and/or, optionally, by impressing the pigment into the orientable polymer composition prior to calibrator (for example, by using rollers, a doctor blade, or a converging die) and then drawn out into streaks during the drawing step.

In another desirable embodiment, dispose colorant in a specific pattern on an orientable polymer composition after the orientable polymer composition exits an extruder and before the orientable polymer composition enters a calibrator. Dispose colorant, for example, by means of an ink roller, embossing device, ink-jet device or any other deposition means. The colorant may be disposed in a repeating pattern by using, for example, a patterned roller to dispose the colorant onto an orientable polymer composition. The roller can contain a pattern around its perimeter that contacts and disposes colorant onto an orientable polymer composition in a repeated pattern.

In a particularly desirable embodiment, after an orientable polymer composition exits an extruder and before it enters a calibrator dispose onto one or more than one surface of the orientable polymer composition a colorant comprising a pigment within a molded thermoplastic polymer matrix (that is, the colorant is a shaped article). The molded thermoplastic polymer matrix may be in a form of a circular shape or a spiral (especially an elongated spiral like a paperclip) or any other desirable shape. A spiral, especially an elongated spiral is desirable in order to create ring-like grain patterns to impart a wood-like appearance to the orientable polymer composition after drawing. The molded thermoplastic polymer matrix containing pigment (that is, the colorant), becomes embedded into the orientable polymer composition within the calibrator and/or, optionally, by impressing the colorant into the orientable polymer composition prior to calibrator (for example, by using pressure applying means such as rollers), thereby disposing colorant in a very precise pattern within the orientable polymer composition yet proximate to the orientable polymer composition's surface. The colorant desirably comprises a pigment in a thermoplastic matrix having a softening temperature lower than the drawing temperature.

In yet another embodiment, that can be independent from or can be in combination with any of the other embodiments, dispose colorant in a specific pattern on an orientable polymer composition just before the orientable polymer composition enters a solid state drawing die. Dispose colorant, for example, by means of an ink roller, embossing device, ink-jet device, stamp or any other deposition means. The colorant may be disposed in a repeating pattern by using, for example, a patterned roller to dispose the colorant onto an orientable polymer composition. The roller can contain a pattern around its perimeter that contacts and disposes colorant onto an orientable polymer composition in a repeated pattern.

Apply the colorant to the orientable polymer composition in the form of a pattern that has a pattern width extending in a dimension perpendicular to the drawing direction (“width dimension”). Determine the pattern width of a pattern by measuring the widest expanse in a dimension perpendicular to the drawing dimension that an individual colorant feature or collection of colorant features occupies on or in an orientable polymer composition. Features that traverse a single line extending in the width dimension of a polymer composition are all part of a single pattern.

Both as applied and after forming an OPC, a pattern can comprise a single continuous colorant domain or comprise multiple discrete colorant domains that work together to form a visually recognizable pattern. Desirably, the pattern is non-linear and more desirably comprises or consists of one or more than one continuous non-linear domain. A colorant pattern can be a continuous non-linear domain. Application of a colorant may comprise applying multiple colorant patterns onto an orientable polymer composition either in a manner so that multiple colorant patterns overlap (cross one another) or so that each colorant pattern is discrete from one another or a combination of some patterns overlapping and some being discrete from one another. Similarly, an OPC resulting from the present process (an OPC of the present invention) may comprise multiple colorant patterns on an orientable polymer composition either overlapping one another (cross one another) or discrete from one another, or a combination of some overlapping and some discrete from one another.

For example, a single straight line extending in the drawing direction has a pattern width corresponding to the width of the line. A series of parallel lines that extend in the drawing direction but reside next to one another so as to all traverse a single line extending in the width dimension of the polymer composition have a pattern width corresponding to the distance between the two lines that are most remote from one another plus the width of each of the two most remote lines as measured in the width dimension of the polymer composition. A single line that spirals, loops, or turns so as to traverse a line extending in a polymer composition's width dimension has a pattern width corresponding to the distance between two portions of the line that are most remote from one another along the line extending in the polymer composition's width dimension.

A colorant pattern can experience fine distortions as a result of inhomogeneous movement of polymers while drawing. A colorant pattern will undergo elongation during drawing. However, when the polymers proximate to colorant move inhomogeneously the colorant pattern undergoes inhomogeneous distortions in addition to elongation. The inhomogeneous distortions are generally fine-scaled relative to the entire (gross) colorant pattern and so the colorant pattern remains recognizable. Inhomogeneous polymer movement, and hence inhomogeneous distortion of a colorant pattern, is caused by any of a number of influences including orientable polymer shape, temperature profile, temperature fluctuations, fluctuations in draw rate and polymer compositional changes and differential friction across the drawing die surface. Due to the number of influences on inhomogeneous polymer movement, distortions in colorant pattern can appear random.

In a particularly desirable embodiment of the present invention, draw a polymer composition to a non-cylindrical shape. Typically, in the practice of this particularly desirable embodiment, the orientable polymer composition has a non-cylindrical shape prior to drawing. Drawing to a non-cylindrical shape, particularly from a non-cylindrical shape, encourages inhomogeneous movement of polymers at and proximate to the polymer composition's surface, which in turn can induce inhomogeneous distortion of the color patterns on and proximate to the polymer composition's surface.

Without being bound by theory, it is believed that inhomogeneous polymer movement tends to be encouraged when there are points on the surface of a polymer composition in a cross section of the polymer composition that are not equidistant from the centroid of the cross section (that is, for a non-cylindrical polymer composition). Polymers on the surface of the polymer composition that are furthest from the centroid tend to move in the drawing direction later in time than surface polymers that are closer to the centroid when all other influences are equal (for example, when the cross sectional temperature profile and drawing rate of the polymer composition is uniform and constant while drawing). Modifying the cross sectional temperature profile of a polymer composition can modify the polymer movement and create inhomogeneous movement of various kinds, such as faster movement proximate to one edge of the polymer than proximate to another edge. As a result of inhomogeneous polymer movement, a line around the circumference of such a polymer composition and in a plane of a cross section of the composition becomes distorted and no longer resides on a plane in a single cross section of the polymer composition after drawing.

The process of present invention desirably includes adding colorant to a polymer composition so as to form a colorant pattern having a pattern width of five millimeters (mm) or more, preferably 10 mm or more, more preferably 25 mm or more, still more preferably 50 mm or more and can have a pattern width of 75 mm or more. The maximum width of a pattern at any cross section of an orientable polymer composition is limited only by the circumference of the cross section of the orientable polymer composition such that the pattern width is equal to or less than the cross section circumference. Typically, a pattern has a pattern width that is equal to or less than the width of a surface of the orientable polymer composition. Width is a measure of extension in the width dimension (that is, perpendicular to the drawing direction). A colorant pattern having a width of five millimeters or more is desirable to create a pattern in a drawn article that has a shape visibly influenced or distorted by inhomogeneous movement of surface polymers during drawing. When a colorant pattern has a pattern width of less than five millimeters, the pattern tends to assume what visibly appears to be a homogeneous elongation of the pattern in the drawing direction. The ink markings used to determine linear draw ratio in the prior art references of Newson and Maine, cited above, are likely of negligible width (certainly less than five millimeters) or else the markings would be expected to be distorted, causing an accurate measurement of marking elongation to be difficult.

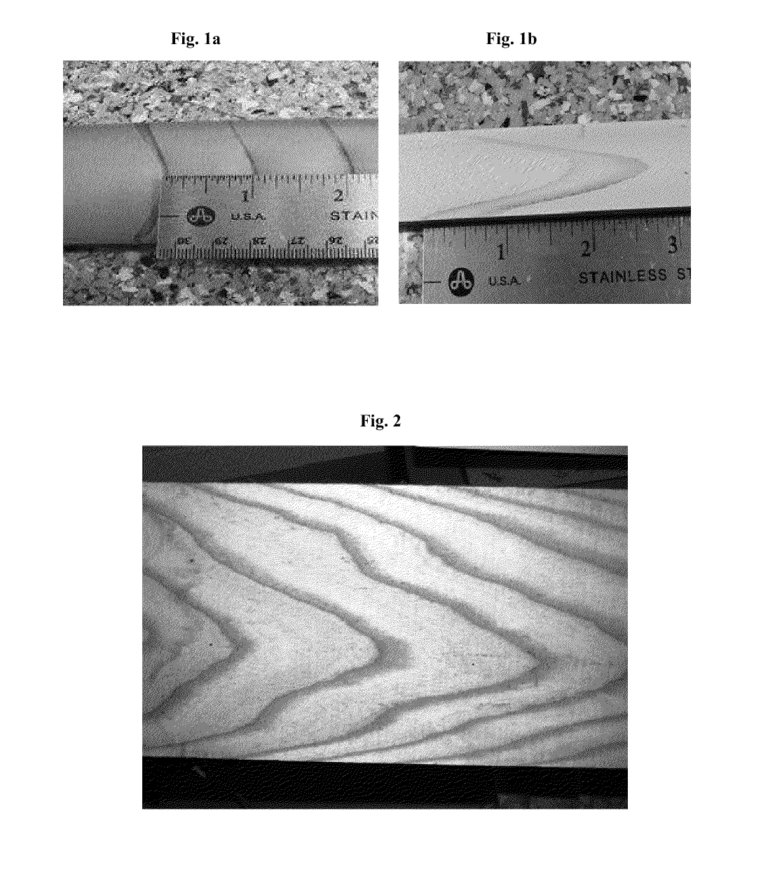

Moreover, it surprisingly appears that surface polymers tend to spread out more as they are more distant from the centroid of a cross section. Hence, a line drawn across the width of a major surface of a board having a rectangular cross section will become a chevron-like shape after drawing with the point of the chevron central along the width and spread out more than the tails of the chevron that are proximate to the edges of the width. This distortion of a line is desirable particular for preparing patterns resembling grain in flat sawn and nearly flat sawn wood boards, which also can have chevron-like patterns with the point broader than the tails. As a result, drawing an orientable polymer composition to a non-cylindrical shape in the process of the present invention can produce an unexpected advantage in being able to distort colorant lines and patterns into realistic wood-grain type patterns in an OPC. (See, for example, FIGS. 1a, 1b and 2).

Inhomogeneous surface polymer movement for non-cylindrical polymer compositions becomes more evident upon increasing drawing rate. The most pronounced distortion of colorant patterns occurs with drawing rates of 2.4 m/min or faster, preferably 3.7 m/min or faster.

The inhomogeneity in surface polymer movement also becomes more pronounced as the difference in distance to the centroid between two locations on the surface increases. In order to achieve optimal distortion of colorant patterns, particularly in achieving wood-like grain patterns, the polymer composition (and the resulting OPC) desirably has a shape where two points on the composition surface that reside on a single cross section differ in their distance to the centroid of the cross section by a factor of two or more, preferably a factor of four or more and can differ by a factor of five or more, ten or more, even 100 or more. Generally, the distances differ by a factor of 10,000 or less, preferably 1,000 or less for practicality, but there is no theoretical maximum difference.

The process of the present invention desirably introduces polymer orientation primarily in one dimension, more desirably exclusively in one dimension in the resulting OPC (that is, the OPC has a dimension of primary orientation). Orientation “primarily” in one dimension can include orientation in another dimension, but to a lesser extent that orientation in the one primary dimension. Such an embodiment is distinct from biaxially oriented OPCs that are oriented equally in two orthogonal dimensions. Moreover, it is particularly desirable that an OPC be oriented primarily in one of two orthogonal dimensions in a plane containing colorant when colorant resides an a planar surface of the OPC. This particularly desirable process of the present invention is distinct from a biaxial orientation process where orientation occurs to an equal extent in two orthogonal directions defining a plane which is parallel to a planar surface of an orientable polymer composition on which colorant was added. When a plane containing the colorant is biaxially oriented to an equal extent, the particularly desirable chevron-like distortion of the colorant pattern does not occur to any appreciable extent.

The process of the present invention prepares an OPC of the present invention. The OPC comprises an orientable polymer composition as described above and a colorant as described above. The OPC may further comprise filler as described above. The OPC of the present invention is desirably non-cylindrical so as to contain one or more than one distorted colorant pattern as described above.

The OPC is unique in that it typically comprises a colorant preferentially located proximate to a surface of the OPC as opposed to the core of the OPC. That means that in a cross section of the OPC, colorant concentration will be more proximate to a surface as opposed to the core of the OPC. One may discern whether colorant is preferentially located proximate to a surface as opposed to core by plotting the concentration of colorant as a function of depth into an OPC extending in a straight line from a surface of the OPC to the core of the OPC. The distribution for an OPC of the present invention that has colorant preferentially located proximate to a surface of the OPC will reveal that most if not all of the colorant resides closer to a surface of the OPC than the core of the OPC. Usually, colorant will reside exclusively within ten millimeters, typically within five millimeters, preferably within three millimeters and can reside exclusively within two millimeters or even one millimeter of a surface of an OPC of the present invention. A colorant resides exclusively within a distance of a surface if all of the colorant resides in that portion of the OPC within that distance from a surface of the OPC. For example, if colorant resides exclusively within five millimeters of a surface of an OPC, all colorant is within a shell having a thickness of five millimeters around the OPC that contains the OPC's surface.

In one desirable embodiment of the OPC of the present invention, colorant resides on recessed portions of the surface of the OPC. Make such an OPC, for example, by impressing colorant into a softened orientable polymer composition prior to a calibrator using an embossing printer or by using a hot embossing printer to impress colorant into the orientable polymer composition after the calibrator. Having colorant on a recessed portion of the surface protects the colorant from wear and abrasion, enhancing the wearability and scuff resistance of the color pattern.

OPCs of the present invention desirably have colorant embedded into and below a surface of the OPC. Such an OPC desirably comprises colorant extending at least one millimeter, preferably at least two millimeters and can extend three millimeters or more, even five millimeters or more below a surface of the OPC. Having colorant embedded into and below a surface of the OPC protects the colorant from wear and abrasion, enhancing the wearability and scuff resistance of the color pattern.

OPCs of the present invention may contain a coating on one or more than one surface. Coatings can help increase the wear (scuff) resistance and/or visual appearance of the OPC. For instance, a coating can increase gloss or matte finish or impart a more wear-resistant surface to an OPC. Application of a protective coating typically would occur after drawing the polymer composition by spraying, roller application or any other coating means. Suitable coatings include acrylics (hybrids and blends) including polyacrylates, alkyds, chlorinated rubber, epoxies, phenolics, polyesters, polyurethanes, shellac, latexes, powder coatings, silicones, solvent based coatings, radiation-cured coatings, ultra-violet-cured coatings. It may be desirable to apply a primer to the OPC or corona-treat the OPC surface prior to applying a coating in order to enhance adhesion of the coating to the OPC

Alternatively, OPCs of the present invention may be free of coatings, particularly over the colorant pattern. Even without a protective coating, decorative patterns in OPCs of the present invention can have desirable abrasion resistance largely because the colorant forming the decorative pattern is adhesively compatible with the OPC. Enhanced abrasion resistance (or wear resistance) is possible by incorporating colorant on recessed portion of an OPC surface and/or embedding the colorant forming the decorative pattern through a surface of the orientable polymer composition during manufacture of the OPC and thereby establishing a colorant pattern that is embedded through and below the surface of an OPC.

The following examples illustrate embodiments of the present invention.

### EXAMPLES

Prepare each of the Examples using the following general procedure. The Examples differ by one or more than one of: where colorant is added, how the colorant is added, what colorant is added and how the colorant is patterned.

General Procedure

Prepare the following examples by first preparing a polymer billet and then drawing the polymer billet through a drawing die to create an OPC. The drawing step occurs remote in time from preparation of the polymer billet. However, one of ordinary skill in the art can readily modify the process to a continuous process by directing the polymer billet directly from the calibrator into and through the drawing die and expect similar or identical results. FIG. 3 illustrates an exemplary continuous process set up.

Prepare an orientable polymer composition containing 46 wt % talc and 54 wt % polypropylene by pre-compounding the polypropylene polymer with talc in a twin screw extruder at 190° C. The polypropylene is a nucleated polypropylene-ethylene random copolymer having 0.5 wt % ethylene component and a melt flow rate of 3 (for example, INSPIRE® D404.01 available from The Dow Chemical Company, INSPIRE is a trademark of The Dow Chemical Company). The talc is actually a composition of 50-60 wt % talc and 40-50 wt % magnesium carbonates that has a mean diameter of 16.4 microns (for example, TC-100 From Luzenac).

Feed the orientable polymer composition into a single screw extruder operating at approximately 190° C. Extrude the orientable polymer composition through a rectangular billet die having dimensions of 5.08 centimeters wide by 1.52 centimeters high. Direct the extruded orientable polymer composition through a calibrator having opening dimensions of 5.08 centimeters wide by 1.52 centimeters high and through a haul off device (for example, a caterpillar puller). The entrance to the calibrator is about 7.5 centimeters from the exit of the extruder.

Use the haul off device to draw the orientable polymer composition at a rate faster than the orientable polymer composition is extruding from the extruder. That will cause the orientable polymer composition to neck to a cross sectional dimension smaller than the opening dimensions of the calibrator and extrusion die. Draw the polymer in such a manner so as to create a narrow length of billet that has small enough dimensions to extend through the drawing die (described below) and to another haul off device. Once the narrow length of billet is long enough, slow the haul off device gradually to a constant speed that maintains the polymer cross sectional dimensions equivalent to that of the calibrator opening and the orientable polymer composition just contacts the walls of the calibrator. The calibrator then serves to smooth the surface of the billet to a uniform rectangular shape. Cool the orientable polymer composition after it exits the calibrator using a water spray and water at a temperature in a range of 20-40° C. Continue until obtaining a length of billet that is approximately four meters long. At this point the billet has negligible void volume. Cut the billet for later drawing and repeat the process to produce billets for drawing.

Draw each billet through a solid state drawing die to create an OPC. The drawing die is a proportional drawing die (although, the drawing die does not need to be a proportional drawing die). The drawing die is a converging die that has a shaping channel that continually tapers at a constant angle from an entrance opening to an exit opening such that any cross section of the shaping channel is proportional to any other section of the shaping channel. The shaping channel has a rectangular cross section with sides that each taper at a 15° angle towards a centroid line extending through the shaping channel and a top and bottom that each taper at a 4.6° angle towards the centroid line. The centroid line extends through the centroid of each cross section of the shaping channel. The top and bottom of the shaping channel each have a width extending parallel to the 5.08 centimeter pre-drawn dimension of the billet and the sides of the shaping channel each have a height extending parallel to the 1.52 centimeter pre-drawn dimension of the billet when drawing the billet through the die. The exit opening dimensions of the drawing die are 3.493 centimeters by 1.046 centimeters.

Prior to drawing, condition each billet and the drawing die to a drawing temperature (Td) that is about 148° C. (approximately 15° C. below the softening temperature of the orientable polymer composition).

After conditioning the temperature of the billet, feed the billet through the drawing die (narrow length of billet first) and into a haul off device (for example, a caterpillar puller). Draw the billet through the drawing die using the haul off device at a drawing rate. Gradually increase the drawing rate until achieve a drawing rate of 5.8 meters per minute unless otherwise indicated. Cavitation occurs within orientable polymer composition as drawing occurs. As a result, the orientable polymer composition experiences a decrease in density during drawing. The orientable polymer composition experiences some free drawing after exiting the die and necking of the orientable polymer composition is complete when the cross sectional dimensions of the orientable polymer composition are approximately 2.54 centimeters wide and 0.76 centimeters thick (the thickness dimension corresponds with the height dimension of the calibrator and the 1.52 centimeter pre-drawn dimension of the billet).

For a continuous process, modify the above procedure by feeding the narrow length of orientable polymer composition through the drawing die and into another haul off device. Rather than cutting the billet to lengths before drawing, directly draw the billet from the extruder, through the calibrator and through the drawing die.

### Example 1

### Illustration of Inhomogeneous Surface Polymer Movement

After the orientable polymer composition has exited the calibrator but prior to drawing, mark a series of straight lines extending across the width of the orientable polymer composition using a Sharpie™ brand permanent marker (purple in color, Sharpie is a trademark of Sanford, L. P. Newell Operating Company). FIG. 1a illustrates an example of the orientable polymer composition after exiting the calibrator (direction of polymer movement is to the right). The figure reveals the effect of inhomogeneous movement of the polymers near the surface of the polymer composition after having gone through the calibrator, evidenced by the chevron-like curve to the lines.

Draw the orientable polymer composition through a drawing die as described above. FIG. 1b illustrates the resulting lines, which have become dramatically non-linear with that portion of the line central and most proximate to the centroid of a cross section having traveled further in the drawing direction and broadened more than portions of the line more proximate to the edges and more remote from cross sectional centroid. Drawing direction is to the right in the figure. This difference in broadening would have made it difficult to determine a precise linear draw ratio in the Newson and Maine references if their lines had non-negligible width since the line may have extended different amounts across the line's width.

Colorant Depth. Determine how far the colorant penetrates into the polymer composition by analyzing microtomed cross sections of the OPC. Polish an OPC cross section that includes a pigmented area using room temperature microtomy techniques using a Micro Star diamond knife. Examine digital images using a Nikon Epiphot inverted microscope equipped with a Javelin Vidichip black and white CCTV camera at 200×, 400× and 100× magnifications. Calibrate the magnifications using an AO reticle (Catalog number 1400) with a scale of 0.02 millimeters. Measure colorant depth using Photoshop 5.0 software by calculating the pigment penetration into the surrounding OPC based on the image magnification. In Example 1, the colorant penetrates to a depth of 0.004 millimeters.

Colorant Scuff Resistance. Determine the scuff resistance of the colorant pattern by rubbing a Scotch Brite Medium Duty 74 pad across the colorant pattern in the width dimension in sets of ten cycles. One cycle requires rubbing first in one direction across an entire width of a sample and then back across the width of the sample in the opposing direction. Apply five to seven pounds of force against the sample surface with the pad. Scuff resistance results identify how may sets of ten cycles are necessary to remove the colorant pattern from a sample. The colorant pattern in Example 1 disappeared after six sets.

### Example 2

### Lines Extending in Drawing Direction

After the orientable polymer composition has exited the calibrator but prior to drawing, mark a series of lines extending in the drawing direction and spaced seven millimeters apart using a black Sharpie brand permanent marker. FIG. 4a illustrates an example of the orientable polymer composition having lines extending in the drawing direction prior to drawing.

Draw the orientable polymer composition at 2.4 m/min.

FIG. 4b illustrates the lines after drawing the orientable polymer composition. Polymer motion through the calibrator and drawing die is to the left in these figures. FIG. 4b shows that the lines are elongated and the inhomogeneous displacement of the lines—it is visually apparent that the lines more centrally located to the billet width (that is, closer to the cross sectional centroid of the polymer composition) traveled along the drawing direction later than the lines less centrally located on the billet width (that is, further from the cross sectional centroid of the polymer composition) when drawing at a drawing rate of 2.4 meters per minute or more for a billet having a rectangular cross section of dimensions 5.1 centimeters by 1.5 centimeters. This Example illustrates inhomogeneous surface polymer movement of the non-cylindrical polymer composition during drawing.

The lines in Example 2 also illustrate that the inhomogeneous surface polymer movement is not apparent in any single line of negligible width, as is likely used to determine linear draw ratio by marking elongation in the Newson and Maine articles cited earlier. Rather, markings establishing a pattern spanning a certain width of the drawn article are necessary to render the effect visually apparent.

The spacing of the lines from one another indicates that a pattern spacing of at least five millimeters is sufficient to recognize the inhomogeneous surface polymer movement discovered with the present invention when using a drawing rate of 2.4 meters per minute or more and a rectangular billet having dimensions of 5.1 centimeters by 1.5 centimeters.

Colorant Depth, and Colorant Scuff Resistance is the same as for Example 1.

### Example 3

### Addition of Colorant After Extruder and Before Calibrator

Example 3 illustrates various embodiments of the present invention wherein the process includes addition of colorant to an orientable polymer composition after the extruder and before the calibrator.

Neat Pigment

### Example 3a

The colorant is pigment red 265 powder (cerium sulfite available as Neoler® Red S from Rhodia, Neolor is a trademark of Rhodia Electronics and Catalysis)

### Example 3b

The colorant is pigment red 101 powder (iron III oxide available as Bayferrox® 140M from Bayer, Bayferrox is a trademark of Bayer Aktiengesellschaft Corp.)

### Example 3c

The colorant is pigment brown 24 powder (mixed metal oxides available as Sicotan® K2111SG from BASF, Sicotan is a trademark of BASF Aktiengesellschaft Corporation)

### Examples 3d and 3e

The colorant is black powder (carbon black)

For Examples 3a through 3e sprinkle colorant onto a primary surface of a billet after the billet exits the extruder and before the billet enters the calibrator such that the colorant pattern extends the full width across the width of the primary surface of the billet (5.1 centimeters). The calibrator compresses at least a portion of the colorant into the billet as the billet proceeds through the calibrator. Upon drawing the billet, the colorant forms streaks in the resulting OPC. Table 1 provides characteristics of the color pattern in the OPC using similar procedures as described for Example 1.

TABLE 1

| | Colorant Depth | Colorant Scuff Resistance |
|---|---|---|
| Example | (millimeters) | (sets of 10 rub cycles) |
| 3a | 0.022 | 2 |
| 3b | 0.0012 | 3 |
| 3c | 0.046 | 2 |
| 3d | 0.0034 | 3 |
| 3e | 0.0047 | 3 |

Examples 3a-3e illustrate embodiments of the present invention that utilize a process of disposing colorant onto an orientable polymer composition billet prior to calibrating in order to ultimately achieve an OPC have decorative designs due to the colorant embedded into the surface of the OPC without having to have colorant residing all the way through the OPC.

Pigment Compounded in Organic Polymer

The colorant in Example 3f is a pellet comprising black pigment compounded in high density polyethylene (15 wt % 200 mesh ground rubber powder (2008-4306 from Lehigh Technology) in 73 85 wt % D404 PP). The pellets are approximately 1.6 millimeters (0.0625 inches) in diameter and 3.2 millimeters (0.125 inches) long.

The colorant in Example 3g is a pellet comprising mocha pigment compounded in high density polyethylene. The pigment in the high density polyethylene comprises 0.2 wt % pigment yellow no. 19; 0.42 wt % iron oxide and 0.07 wt % carbon black with wt % values based on total colorant composition weight. The pellets are approximately 1.6 millimeters (0.0625 inches) in diameter and 3.2 millimeters (0.125 inches) long.

As in Examples 3a-3e, dispose the colorant pellets onto a primary surface of a billet after the billet exits the extruder and prior to entering the calibrator. The colorant pellets become embedded into the billet as the billet travels through the calibrator. Upon drawing the resulting billet containing impregnated colorant pellets, the pellets deform to create colored streaks in the resulting OPC. Table 2 contains characteristics of Examples 3g and 3h using similar test methods as those in Example 1.

TABLE 2

| | Colorant Depth | Colorant Scuff Resistance |
|---|---|---|
| Example | (mm) | (sets of 10 rub cycles) |
| 3f | 1.6 | >10* |
| 3g | 0.014 | >4** |

*colorant pattern did not disappear after 10 sets of 10 cycles.
**colorant did not disappear after 4 sets of 10 cycles. Further sets were not conducted.

Example 3f and 3g illustrate embodiments of the present invention that utilize a compounded pigment in thermoplastic polymer pellets as a colorant to obtain an OPC having a decorative design on its surface resulting from pigment that is embedded into the surface of the OPC but not extending all the way through the OPC. Examples 3f and 3g reveal the enhancement in Scuff Resistance when a colorant is embedded deeper into an OPC when compared to Examples 3a-3e.

### Example 4

### Addition of Colorant After Calibrator and Before Drawing

Example 4 illustrates various embodiments of the present invention wherein the process includes addition of colorant to an orientable polymer composition after the calibrator and before drawing.

Compounded Pigment

The colorant for Example 4a is a pellet comprising redwood pigment compounded in high density polyethylene. The pigment in the high density polyethylene comprises 0.2 wt % pigment yellow no. 119 and 0.86 wt % iron oxide with wt % values based on total colorant composition weight. The pellets are approximately 1.6 millimeters (0.0625 inches) in diameter and 3.2 millimeters (0.125 inches) long.

Dispose the colorant pellets onto a surface of a main portion of an orientable polymer composition billet after the billet exits a calibrator and prior to drawing the billet through a drawing die. As the billet travels though the drawing die the colorant pellets become embedded into the surface of the billet and created decorative color patterns in the resulting OPC. The decorative pattern is due to the pigment embedded into the surface of the OPC without having to have pigments residing all the way through the OPC.

The colorant extends to a depth of 0.0056 millimeters into the surface of the OPC and has a Scuff Resistance of five sets of ten cycles to remove the colorant pattern.

Example 4 illustrates an embodiment of the present invention where pigment creates a decorative pattern in an OPC upon introduction of the pigment as a pellet of pigment in thermoplastic polymer to a surface of an orientable polymer composition billet after the billet exits a calibrator and prior to drawing the billet through a drawing die. The Examples further illustrate such embodiments of the present invention wherein pigment is embedded into the OPC surface in a decorative pattern.

Neat Pigment

For Example 4b, dispose colorant (carbon black powder) onto a surface of a main portion of a billet after the calibrator and prior to the drawing die. As the billet travels though the drawing die the colorant becomes embedded into the surface of the billet and created decorative color patterns in the resulting OPC. The decorative pattern is due to the pigment embedded into the surface of the OPC without having to have pigments residing all the way through the OPC. Using characterization procedures as described for Example 1, Example 4b has a colorant depth of 0.0047 millimeters into the OPC surface and a Scuff Resistance of three sets of ten cycles to remove the colorant pattern.

Example 4b illustrates embodiments of the present invention where neat pigment creates a decorative pattern in an OPC upon introduction of the pigment to a surface of an orientable polymer composition billet after the billet exits a calibrator and prior to drawing the billet through a drawing die. The Examples further illustrate such embodiments of the present invention wherein pigment is embedded into the OPC surface in a decorative pattern.

Ink Patterns

For Examples 4c through 4j use a black Sharpie brand permanent marker to draw patterns onto a surface of a billet after the billet has gone through a calibrator and before the billet goes through a drawing die. The Examples differ by what pattern is drawn on the billet (for example, straight lines, diagonal lines, circles, concentric circles, spirals. See Table 4 for specific patterns for each Example). Notably, these examples have patterns repeatedly drawn on them but similar results would occur if a printing roller repeatedly imprinted an ink design onto the billet surface.

A drawing die is not necessary to achieve similar results by free drawing. That is, similar results of an OPC having a decorative pattern on a surface will occur by free drawing a billet after disposing ink patterns on the billet instead of drawing the billet through a drawing die. Table 4 contains characteristics of the resulting OPCs using the characterization procedures described in Example 1.

TABLE 4

| | | Colorant | Colorant Scuff Resistance |
|---|---|---|---|
| Example | Colorant Pattern | Depth (mm) | (sets of 10 rub cycles) |
| 4c | Circles | 0.015 | 6 |
| 4d | Hash marks | 0.015 | 6 |
| 4e | Cup | 0.015 | 6 |
| 4f | Wood grain | 0.015 | 6 |
| 4g | Pin wheel | 0.015 | 6 |
| 4h | Diamonds | 0.015 | 6 |
| 4i | Dashes | 0.015 | 6 |
| 4j | Check mark | 0.015 | 6 |

Examples 4c-4j, particularly in combination with Examples 2 and 3 illustrate the freedom the present process affords in applying specific patterns to a polymer composition prior to drawing in order to obtain elongated and even inhomogeneously distorted versions of those patterns.

1. A process for preparing an oriented polymer composition comprising the steps of:
a. providing a calibrator, a colorant, and an orientable polymer composition that has a surface, softening temperature and a width;
b. extruding the orientable polymer composition at a temperature above the orientable polymer composition's softening temperature;
c. directing the orientable polymer composition through a calibrator;
d. conditioning the orientable polymer composition to a drawing temperature at which the polymer composition is in a solid state; and
e. initiating drawing of the orientable polymer composition while the orientable composition is in a solid state and drawing the orientable polymer composition into an oriented polymer composition;
wherein, step (d) occurs during or after step (c) but occurs prior to step (e) and further comprising a step of adding a colorant to one or more than one surface of the orientable polymer composition in one or both of the following places in the process: (i) after exiting the extruder and before exiting the calibrator; and (ii) after exiting the calibrator and before completion of the drawing step; and wherein the colorant is part of a colorant pattern that has a width of at least five millimeters.

2. The process of claim 1, wherein addition of colorant during (i) occurs prior to the calibrator.

3. The process of claim 1, wherein drawing in step (e) includes drawing the orientable polymer composition through a drawing die wherein the orientable polymer composition is in a solid state as it enters the drawing die and addition of colorant during (ii) occurs prior to a drawing die.

4. The process of claim 1, wherein the step of adding colorant to a surface includes directly impressing colorant into the surface so that the colorant resides in a recessed portion of the orientable polymer composition's surface.

5. The process of claim 1, wherein the colorant resides exclusively within five millimeters of a surface of the oriented polymer composition.

6. The process of claim 1, wherein step (c) continuously follows step (b) and steps (d) and (e) continuously follow step (c).

7. The process of claim 1, wherein step (c) continuously follows step (b) and colorant is added to at least one surface of the orientable polymer composition between steps (b) and (c).

8. The process of claim 1, wherein the colorant comprises a pigment in a carrier wherein the carrier is selected from a group consisting of a thermoplastic polymer matrix, organic liquids, organic solvents, aqueous liquids and aqueous solvents.

9. The process of claim 8, wherein the colorant comprises a pigment in a thermoplastic polymer matrix.

10. The process of claim 9, wherein the polymer matrix has a softening temperature lower than the orientable polymer composition's softening temperature.

11. The process of claim 9, wherein the colorant has a form of a circular or spiral shape.

12. The process of claim 9, wherein the thermoplastic polymer matrix comprises one or more semi-crystalline polymer.

13. The process of claim 1, wherein the colorant is adhesively compatible with the orientable polymer composition.

14. The process of claim 1, wherein the step of adding colorant comprises applying colorant in a non-linear pattern.

15. An article of manufacture that is an orientable polymer composition that has been oriented into an oriented polymer composition, the oriented polymer composition comprising an orientable polymer composition and a colorant; wherein the oriented polymer composition has at least one surface and a core, and a dimension of primary orientation and wherein the colorant is part of a colorant pattern having a width of at least five millimeters.

16. The oriented polymer composition of claim 15, wherein at least a portion of the colorant extends to a depth of at least one millimeter below a surface of the oriented polymer composition and is preferentially located proximate to the surface of the oriented polymer composition as opposed to the core of the oriented polymer composition.

17. The oriented polymer composition of claim 15, wherein colorant is exclusively located within five millimeters of at least one surface of the oriented polymer composition.

18. The oriented polymer composition of claim 15, wherein the colorant is adhesively compatible with the orientable polymer composition.

19. The oriented polymer composition of claim 15, wherein the oriented polymer composition is non-cylindrical.

20. The oriented polymer composition of claim 15, wherein the colorant forms a non-linear pattern.
